(19) United States
(12) Patent Application Publication
(10) Pub. No.: US 2002/0064086 A1
(43) Pub. Date: May 30, 2002

(54) Continuous mixing apparatus

(76) Inventors: Hideyuki Mori, Fukui Prefecture (JP); Toyohiko Yamadera, Chiba Prefecture (JP); Mitsuo Hamada, Chiba Prefecture (JP)

Correspondence Address: DOW CORNING CORPORATION CO1232, 2200 W. SALZBURG ROAD, P.O. BOX 994, MIDLAND, MI, 48686-0994, US

(21) Appl. No.: 09/993,594

(22) Filed: Nov. 5, 2001

(30) Foreign Application Priority Data
Nov. 30, 2000 (JP) JP 2000-364678

(51) Int. Cl. B01F 7/26; B01F 15/02

(52) U.S. Cl. 366/171.1; 366/172.1; 366/172.2; 366/178.1; 366/294; 366/303; 366/312; 366/317

(57) ABSTRACT

Continuous mixing apparatus provide rapid production of a mixture of high uniformity, low viscosity, low density, high stability after mixing, without an increase in amounts of subsequently supplied liquids. Continuous production of liquid or liquid containing mixtures consists of (i) continuously loading the apparatus casing with materials of different types which are flowable such as different liquids or a powder and a liquid, (ii) mixing the components between independently rotating upper and lower bladed disk turbine impellers to form a coarse mixture, and (iii) mixing the coarse mixture with an additional portion of a liquid being continuously supplied to the casing.

### FIELD OF THE INVENTION

This invention is related to apparatus for continuously mixing materials of different types. More specifically, it relates to mixing apparatus for the continuous preparation of liquid or liquid containing mixtures by (i) continuously loading a casing with fluid materials of different types, e.g., different liquids or a powder and a liquid; (ii) continuously mixing the materials by means of an upper bladed disk turbine impeller and a lower bladed disk turbine impeller which rotate individually with respect to each other to prepare a coarse mixture; and (iii) continuously feeding a liquid into the casing for mixing with the coarse mixture.

### BACKGROUND OF THE INVENTION

Japanese Patent Application Publication 2000-449 describes a process for preparing a water based grease like organopolysiloxane liquid by loading a mixing chamber with a liquid organopolysiloxane, an emulsification agent, and water, and mixing the components with a rotating disk equipped with scrapers. A disadvantage of this process consists in low stability and in coarsening of the grains contained in the emulsion. These problems occur because from the beginning of the process, the emulsification is conducted in a diluted state.

U.S. Pat. No. 4,691,867 (Sep. 8, 1987) describes a continuous mixer for the preparation of a slurry from a fine powder, oil coke, or similar pulverized bodies. The pulverized bodies and a liquid are fed into an upper mixing chamber and mixed in a humidified state by a rotating upper mixing disk. The resulting coarse mixture is sent to a lower mixing chamber where it is converted to a slurry by a rotating lower mixing disk. As coarse mixture flows to the lower mixing chamber with pulsation, the mixture contained in the lower mixing chamber tends to flow back to the upper mixing chamber. As a result, as the pulverized bodies and liquid are loaded into the upper mixing chamber, there is no means to use the mixtures other than in a diluted state. This is not acceptable in order to provide dispersions of the pulverized bodies.

U.S. Pat. No. 5,599,102 (Feb. 4, 1997) discloses a mixing apparatus for the continuous preparation of low viscosity mixtures by (i) loading a mixing chamber with a powdered material and a liquid, (ii) preparing a coarse mixture with a rotating disk, (iii) supplying another portion of the liquid to the rotating disk, and (iv) mixing it with the coarse mixture. A disadvantage of this mixing apparatus is in preparing emulsions. Thus, as the second portion of the liquid comes closer to the level of the rotating disk, the grain size of the particles become too large, and as a result, the mixture becomes unstable. When using this type of device to mix a powder with a liquid, the resulting mixture has too high a viscosity.

### BRIEF SUMMARY OF THE INVENTION

Therefore, it is an object of the invention to provide a continuous mixing apparatus for mixing materials of different types which is capable of preparing mixtures of high stability, quickly, uniformly, without an increase in the level of the liquid, with low viscosity and low density of the mixture. These and other features of the invention will become apparent from a consideration of the detailed description.

### BRIEF DESCRIPTION OF THE SEVERAL VIEWS OF THE DRAWING

FIG. 1 is a vertical sectional view of a continuous mixing apparatus of the invention.

FIG. 2 is a top view of the upper bladed disk turbine impeller of the continuous mixing apparatus.

FIG. 3 is a sectional view of the upper bladed disk turbine impeller of the continuous mixing apparatus.

FIG. 4 is a top view of the lower bladed disk turbine impeller of the continuous mixing apparatus.

FIG. 5 is a sectional view of the lower bladed disk turbine impeller of the continuous mixing apparatus.

### DETAILED DESCRIPTION OF THE INVENTION

The continuous mixing apparatus according to this invention comprises:

(i) an upper bladed disk turbine impeller and a lower bladed disk turbine impeller installed in a mixing chamber of a casing, the impellers being capable of independent rotation;

(ii) an upper ring shaped baffle extending radially inwardly from the inner wall of the casing between the upper bladed disk turbine impeller and the lower bladed disk turbine impeller, the baffle being out of contact with the impellers;

(iii) a lower ring shaped baffle extending radially inwardly from the inner wall of the casing into a cutout portion of the lower bladed disk turbine impeller without contacting the lower bladed disk turbine impeller;

(iv) wherein the mixing chamber of the casing is divided by the upper bladed disk turbine impeller, the upper ring shaped baffle, and the lower bladed disk turbine impeller into an uppermost mixing chamber, an upper mixing chamber, an intermediate mixing chamber, and a lower mixing chamber;

(v) the upper part of the casing being provided with a material loading opening for loading materials of different types into the uppermost mixing chamber;

(vi) a liquid supply pipe passing through the side wall of the casing into the intermediate mixing chamber or into the lower mixing chamber for the supply of liquid into the chambers; and

(vii) a discharge opening formed in the bottom of the mixing chamber for discharging the mixture outside the mixing apparatus from the lower mixing chamber.

In the continuous mixer, materials of different types such as a powder and a liquid, different powders, or different liquids are supplied to the uppermost mixing chamber, move in a radially outward direction over the surface of the disk of the rotating upper bladed disk turbine impeller, and are mixed using shear forces developed between the upper cover of the casing and the flat blades of a bladed disk turbine impeller, as well as shear forces developed between the inner walls of the cylindrical casing and the flat blades of bladed disk turbine impeller.

The mixture produced in this stage flows down into the upper mixing chamber through a gap between the periphery of the disk of the upper bladed disk turbine impeller and the inner wall of the cylindrical casing. In the upper mixing chamber, the mixture is subjected to uniform mixing under the action of shear forces developed between the inner wall of the cylindrical casing and the flat blades of the upper bladed disk turbine impeller, as well as by shearing forces developed between the upper ring shaped baffle and the flat blades of the upper bladed disk turbine impeller.

The mixture then flows down into an intermediate mixing chamber via a gap between the upper ring shaped baffle and the rotating shaft of the upper impeller. In the intermediate mixing chamber, the mixture moves over the surface of the disk of the lower bladed disk turbine impeller, and is further mixed under the effect of shearing forces developed between the inner walls of the cylindrical casing and the blades of the lower bladed disk turbine impeller, as well as by shearing forces developed between the upper ring shaped baffle and the blades of the lower bladed disk turbine impeller.

The mixture produced in this stage flows down into the lower mixing chamber through a gap between the periphery of the disk of the lower bladed disk turbine impeller and the inner wall of the cylindrical casing. An additional portion of the liquid is supplied to the intermediate or lower mixing chamber via a liquid supply tube that passes through the side wall of the casing and combined with the mixture. The mixture is again uniformly mixed under shearing forces developed between the blades of the lower bladed disk turbine impeller, the lower ring shaped baffle, and the inner wall of the cylindrical casing. The resulting uniform mixture with the additional portion of liquid is discharged from the mixer through a discharge opening formed in the bottom of the casing.

One example of a mixture with good flowability is a mixture of a powder with a liquid. The powder does not need be homogeneous and may be a mixture of different powders. Representative powders include starch, wheat, pigments, metal powders, powdered fillers, powdered polymers, or powdered rubbers. Some suitable powdered fillers are fumed silica, hydrophobically surface treated fumed silica, wet process silica, diatomaceous earth, quartz powder, powdered calcium carbonate, powdered magnesium oxide, alumina powder, powdered aluminum hydroxide, and carbon black. Powdered polymers include silicone resin powders and other thermoplastic resin powders.

The liquid can be homogeneous or in the form of a solution. Some suitable examples of liquids suitable for use in the invention are water, aqueous solutions, jellies, edible oils, mineral oils, liquid paraffins, organic solvents, solutions, liquid compounds, and liquid polymers. Some representative examples of liquid compounds are emulsions, surface active agents, thickeners, plasticizers, and stabilizers. Liquid polymers can be represented by liquid silicones, liquid polybutadienes, liquid polybutenes, liquid polyurethanes, and liquid epoxy resins.

As used herein, the term continuous mixing apparatus is intended to include continuous mixers suitable for mixing not only materials of different types, such as (i) powders and liquids, different powders, or different liquids, but also powders of the same species with different shapes and average grain dimensions, (ii) the same liquid but liquids with different viscosities such as gum type diorganopolysiloxanes and low viscosity diorganopolysiloxane, or the same liquid but of different densities. Auxiliary liquids can be included and can be the same or different as the liquid used in the coarse mixture.

Mixtures prepared and discharged from continuous mixing apparatus of the invention can be different depending on the type and mixing ratio of the mixture components. Such mixtures may be in the form of compounds, slurries, pastes, greases, emulsions, dispersions, or solutions.

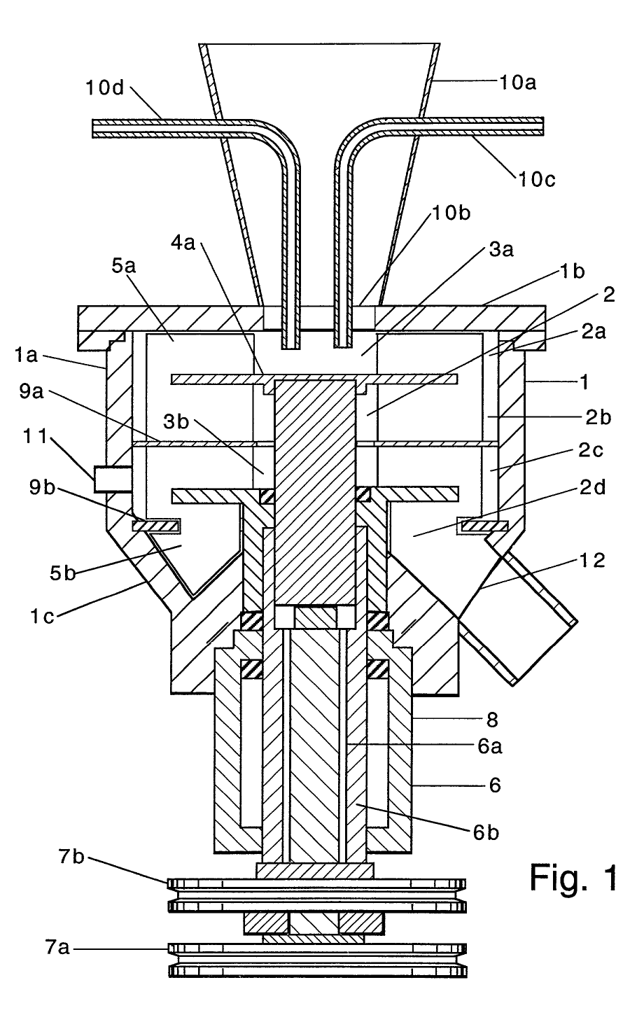

The invention will be described in more detail with reference to the accompanying drawings. In FIG. 1, it can be seen that a mixing chamber 2 is formed in a casing 1 containing an upper bladed disk turbine impeller 3a and a lower bladed disk turbine impeller 3b. The impellers 3a and 3b each rotate from an individual rotary drive and they are installed so that their disk surfaces are arranged horizontally. The upper bladed disk turbine impeller 3a is rigidly fixed to the upper end of rotating shaft 6a. The axis of shaft 6a coincides with the center of disk 4a, and the lower bladed disk turbine impeller 3b is rigidly fixed to the upper end of rotating shaft 6b. The axis of shaft 6b coincides with the center of disk 4b.

Disk 4a is arranged perpendicular to the longitudinal axis of rotating shaft 6a, and disk 4b is arranged perpendicular to the longitudinal axis of rotating shaft 6b. Rotating shaft 6a is inserted into rotating shaft 6b and each shaft rotates independently of one another. At the lower end, rotating shaft 6a supports pulley 7a which is driven for rotation from a drive motor (not shown in the drawing). Similarly, at its lower end, rotating shaft 6b supports pulley 7b which is driven for rotation from a drive motor (not shown in the drawing). Shaft 6b is supported by bearing 8. The circumferential speed of disk 4a is preferably within the range from 3-240 m/sec, preferably 3-60 m/sec. The speed ratio of disk 4a to disk 4b is preferably within the range from 4:1 to 1:1 and cannot be 1:1. A circumferential speed of disk 4a exceeding the upper limit may cause a back flow of the mixture.

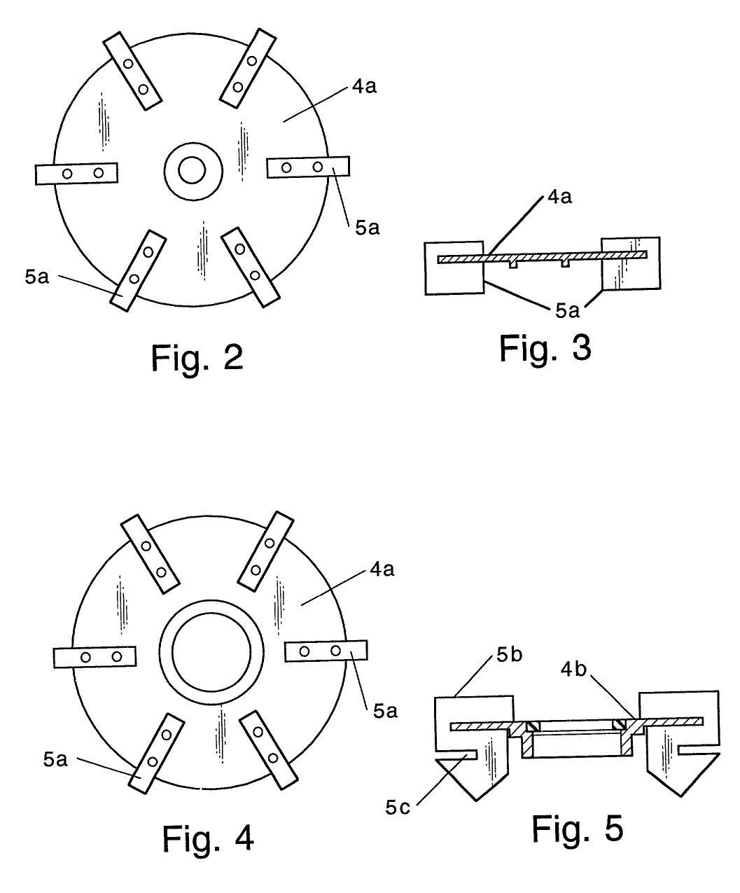

In FIGS. 2 and 3, six flat blades 5a are shown attached to disk 4a so that they extend radially outwardly and are perpendicular to the plane of disk 4a. The number of the blades is not limited to six, and any number of blades 5a can be used in numbers of two or more. The blades 5a should be spaced equally in the circumferential direction. It is not necessary to arrange the blades 5a to be perpendicular to the plane of disk 4a, and so they may be fixed in an inclined position as well. Although blades 5a are shown as being in the form of flat plates arranged radially and vertically, they may have a curved configuration.

As can be seen in FIGS. 4 and 5, six flat blades 5b are attached to disk 4b so that they extend radially outwardly and perpendicular to the plane of disk 4b. The number of blades 5b not limited to six, and so any number of blades can be used in numbers of two or more. The blades 5b should be spaced equally in the circumferential direction. It is not necessary to arrange blades 5b perpendicular to the plane of disk 4b, and so they may be fixed in an inclined position as well. Blades 5b are flat plates arranged radially and vertically. A cutout 5c in each blade 5b extends horizontally inwardly from the periphery of the blades 5b. The cutouts 5c allows rotation of blades 5b with respect to a lower ring type partition 9b.

Upper ring shaped baffle 9a extends radially inwardly from the inner wall of cylindrical part 1a of casing 1 in the space between the upper bladed disk turbine impeller 3a and the lower bladed disk turbine impeller 3b, but out of contact with impellers 3a and 3b. A gap for the passage of the mixture remains between the periphery of the upper ring shaped baffle 9a and rotating shaft 6a. The lower ring type baffle 9b extends radially inwardly from the inner wall of casing 1 at the lower end of cylindrical portion 1a, and passes through the cutouts 5c in blades 5b without contacting the blades 5b. This arrangement allows for the rotation of lower bladed disk turbine impeller 3b. A gap for the passage of the mixture remains between the periphery of the lower ring shaped baffle 9b and rotating shaft 6b.

An uppermost mixing chamber 2a is formed in the mixing chamber of casing 1 between upper cover 1b, the upper bladed disk turbine impeller 3a, and the inner wall of cylindrical portion 1a of casing 1. An upper mixing chamber 2b is formed between the upper bladed disk turbine impeller 3a, the upper ring like baffle 9a, and the inner wall of cylindrical portion 1a of casing 1. Intermediate mixing chamber 2c is formed between the upper ring like baffle 9a, the lower bladed disk turbine impeller 3b, and the inner wall of cylindrical portion 1a of casing 1. Similarly, lower mixing chamber 2d is formed between the lower bladed disk turbine impeller 3b, the inner wall of downward tapered portion 1c of casing 1, and the inner wall of cylindrical portion 1a of casing 1.

A charge loading tube 10a for feeding materials to be mixed into uppermost mixing chamber 2a is attached to the central part of cover 1b on casing 1. Materials are loaded through loading port 10b. Two other material loading pipes 10c and 10d pass into charge loading tube 10a so that their ends are aligned with loading port 10b. Charge loading tube 10a is used primarily for loading powdered materials which normally constitute the largest part of the feed charge. If necessary, either one of loading pipes 10c and 10d can be eliminated or a double pipe can be used in their place. Liquid supply pipe 11 for supplying liquid to intermediate mixing chamber 2c passes through the side wall of cylindrical portion 1a of casing 1. If necessary, liquid supply tube 11 can be inserted into lower mixing chamber 2d into the space between disk 4b and lower ring like baffle 9b.

Alternatively, liquid supply tubes 11 can be introduced into both the intermediate mixing chamber 2c and lower mixing chamber 2d. Downward tapered portion 1c is connected to the lower end of cylindrical portion 1a of casing 1. To accommodate a part of the bearing in the central part of tapered portion 1c, portion 1c terminates in the form of a ring shaped hub with a V-shaped cavity. Discharge tube 12 for unloading a final mixture from the device is formed in the side wall of downward tapered portion 1c of casing 1.

When materials of different types are mixed using continuous mixing apparatus of the invention, a final mixture can be rapidly produced with high uniformity, low viscosity and density, high stability after the mixing, and without an increase in levels of subsequently supplied liquids. In mixing various liquids, as in the preparation of an emulsion of water and a silicone oil, an emulsion of high stability can be rapidly prepared with particles of very small dimension in the emulsion.

Other variations may be made in compounds, compositions, and methods described herein without departing from the essential features of the invention. The embodiments of the invention specifically illustrated herein are exemplary only and not intended as limitations on their scope except as defined in the appended claims.

1. Continuous mixing apparatus comprising:
an upper bladed disk turbine impeller and a lower bladed disk turbine impeller, the impellers being located in a mixing chamber of a casing, the impellers being mounted for independent rotation with respect to one another;
an upper ring shaped baffle extending radially inwardly from the inner wall of the casing between the upper bladed disk turbine impeller and the lower bladed disk turbine impeller, the baffle being arranged out of contact with the impellers;
a lower ring shaped baffle extending radially inwardly from the inner wall of the casing and into a cutout portion in the lower bladed disk turbine impeller so as to be in non-contacting relationship therewith;
the mixing chamber of the casing being divided by the upper bladed disk turbine impeller, the upper ring shaped baffle, and the lower bladed disk turbine impeller, into an uppermost mixing chamber, an upper mixing chamber, an intermediate mixing chamber, and a lower mixing chamber;
the upper part of the casing being provided with a material loading opening for loading materials of different types into the uppermost mixing chamber;
a liquid supply pipe passing through the side wall of the casing into the intermediate mixing chamber or into the lower mixing chamber for supplying liquids into the chambers;
and a discharge opening in the bottom of the mixing chamber for unloading the mixture from the lower mixing chamber.

2. Apparatus according to claim 1 wherein the ratio of circumferential speed of upper bladed disk turbine impeller to circumferential speed of lower bladed disk turbine impeller is 4:1 to 1:1 excluding 1:1.

3. Apparatus according to claim 1 wherein the materials are liquids.

4. Apparatus according to claim 1 wherein the materials are liquids and powders.
